(19) United States
(12) Patent Application Publication
(10) Pub. No.: US 2014/0126061 A1
(43) Pub. Date: May 8, 2014

(54) OPTICAL ELEMENT AND PRODUCTION OF SAME

(71) Applicants: FORSCHUNGSVERBUND BERLIN E.V., Berlin (DE); ALBERT-LUDWIGS-UNIVERSITAET FREIBURG, Freiburg (DE)

(72) Inventors: Ulrike WALLRABE, Karlsruhe (DE); Jens BRUNNE, Freiburg (DE); Michael PAULS, Loerrach (DE); Ruediger GRUNWALD, Berlin (DE)

(21) Appl. No.: 14/064,062

(22) Filed: Oct. 25, 2013

(30) Foreign Application Priority Data
Oct. 26, 2012 (DE) 102012219655.2

(51) Int. Cl. G02B 5/18

(52) U.S. Cl. CPC G02B 5/18; G02B 5/1861; G02B 5/1847
USPC 359/572; 359/576

(57) ABSTRACT

An optical element includes a structured carrier layer having a macrostructure at a main surface and a layer of cured material. The layer of cured material includes an optically smooth surface facing away from the main surface, a macrostructure surface of the surface being dependent on the macrostructure of the carrier layer and on a layer thickness profile of the layer.

### CROSS-REFERENCE TO RELATED APPLICATIONS

This application claims priority from German Patent Application No. 102012219655.2, which was filed on Oct. 26, 2012, and is incorporated herein in its entirety by reference.

Embodiments of the present invention relate to an optical element and to a method of producing same.

### BACKGROUND OF THE INVENTION

Optical elements are understood to include gratings, lenses or curved mirrors, for example. Said optical elements typically comprise smooth surfaces with, e.g., curved, spherical, aspherical or parabolic surface functions. The optical properties are defined by the surface function, in particular via the radius of curvature.

Optical elements are being increasingly miniaturized, which opens up the possibilities of combining different technologies, e.g. optics and electronics. Products originating from this field provide, e.g., electrically adaptable micro-optical systems wherein the optical properties may be adjusted externally, i.e. during operation. For example, in a mirror, the mirror layer may be configured to have the form of a membrane, so that said membrane may be “actuated”, i.e. be actively influenced in terms of shape, by a force ore pressure. Such optical elements based on a membrane with an air gap located behind it often involve a large amount of effort in terms of production, which results in high production cost. In addition, there are limits to the degree of miniaturization that may be performed.

### SUMMARY

According to an embodiment, an optical element may have: a structured carrier layer including a macrostructure at a main surface; and a layer of cured material having an optically smooth surface facing away from the main surface, a macro surface structure of the surface being dependent on the macrostructure of the carrier layer and on a layer thickness profile of the layer.

According to another embodiment, an optical array may have a multitude of adjacently arranged optical elements as claimed in claim 1.

According to another embodiment, a method of producing an optical element may have the steps of: providing a carrier layer; structuring the carrier layer, so that a macrostructure is formed at a main surface; applying a layer of curable material, so that an optically smooth surface facing away from the main surface arises and a macro surface structure of the surface is dependent on the macrostructure of the carrier layer and on a layer thickness profile of the layer.

According to yet another embodiment, a method of producing as claimed in claim 16, may have the step of applying a mirror layer to the layer, so that the mirror layer has the macro surface structure embossed therein and that the mirror layer has an optically smooth surface.

Embodiments of the present invention relate to an optical element having a structured (patterned) carrier layer and a layer of cured material. The structured carrier layer comprises a macro structure having a first main surface. The layer consisting of cured material comprises an optically smooth surface facing away from the main surface, the macro surface structure of the surface being dependent on the macro structure of the carrier layer and on a layer thickness profile of the layer.

Embodiments of the present invention are based on the finding that almost any surface function of an optical element may be created in that a carrier layer such as a base substrate, for example, is structured and is filled up with a material which cures during the production process, for example a dielectric material, which forms the layer having the optical surface. Here, in particular the surface structure of the optical surface is influenced by the curing-induced shrinkage of the layer comprising the curing material. During curing, cross-linking of same occurs, which results in a volume shrinkage, so that the (macroscopic) surface shape of the structured carrier layer can be transferred to the surface of the (optical) layer. In particular, the macro structure of the structured carrier layer is transferred, whereas microstructural roughnesses are not transferred. Consequently, an optically smooth surface of the cured layer advantageously results which either serves directly as an optical surface if the object produced in this manner is designed for transmission, or which may be mirrored so as to be able to operate the optical element in reflection. Thus, the inventive optical element enables a simple design, which has advantageous effects both with regard to production and with regard to the possibility of miniaturization while exhibiting a large amount of flexibility with regard to the surface function.

Due to curing-induced shrinkage and thermal expansion while taking into account the macro structure of the carrier layer, the above-mentioned macro surface structure results from a flat plane. In areas having a previously large layer thickness, more pronounced curing-induced shrinkage, in absolute terms, takes place than in areas having a previously small layer thickness, so that, consequently, an optical geometry and/or the above-mentioned macro surface structure may be produced from one plane if the carrier layer is structured accordingly.

As was mentioned above, the optical element may, in accordance with further embodiments, also comprise a mirror layer arranged on the surface of the layer. Thus, the layer is to be understood to be an intermediate layer, whereas the optical surface is formed by the mirror layer. Therefore, by analogy with the above explanations, the mirror layer may be shaped in accordance with any surface functions. Examples of this are spherical mirrors, parabolic mirrors or axicon mirrors. In accordance with further embodiments, diffraction gratings and diffractive holograms may also be produced.

In accordance with further embodiments, the layer thickness profile of the layer or intermediate layer may be varied, during operation, such that the surface function of the optical surface is adaptable. Adaptation is performed, e.g., electrostatically by applying an electrical voltage exerting an electrostatic force on the intermediate layer or layer, and/or thermally in that the layer or intermediate layer is heated or cooled, so that it expands or contracts, the intermediate layer having a different temperature expansion coefficient than the base substrate. Since, as was mentioned above, the layer comprises a layer thickness profile, different areas will expand identically in terms of percentage, but differently in absolute terms. Thus, the surface functions influencing the optical properties are directly adaptable during operation. It shall be noted that electrostatic adaptation (actuation) is significantly faster than thermal actuation.

A further embodiment provides a method of producing an optical element, comprising the following steps: providing a carrier layer, patterning same and applying a layer of cured material to the carrier layer. The carrier layer is patterned such that a macro structure is formed at a main surface. The layer, for example a dielectric layer or a polymer layer, is applied such that an optically smooth area facing away from the main surface results, and such that, as was already mentioned above, a macro surface layer of the surface depends on the macrostructure of the carrier layer and on a layer thickness profile of the layer.

Advantageously, this production method need not be performed under clean-room conditions since it is based on production technologies such as laser cutting, machining or molding. Consequently, this production method is simple and, in particular, low in cost.

The method may comprise the step of curing, e.g. with the aid of a temperature treatment, so that volume shrinkage and, therefore, internal stresses arise within the layer. Due to said internal stresses, the material of the layer and, thus, the macro surface structure will deform after the curing. In accordance with further embodiments, this production method is performed in that the optical surface is planarized—prior to or during curing—under pressure, which is applied, e.g., via the mirror layer or a different optical layer.

### BRIEF DESCRIPTION OF THE DRAWINGS

Embodiments of the present invention will be detailed subsequently referring to the appended drawings, in which:

FIG. 1a shows a schematic sectional representation of an optical element having an optical geometry in accordance with an embodiment;

FIG. 1b shows a schematic sectional representation of an optical element having a highly pronounced optical geometry in accordance with a further embodiment;

FIG. 2a shows a schematic representation of an optical element, which may be thermally actuated, in accordance with an embodiment;

FIG. 2b shows a schematic representation of an optical element, which may be electrically actuated, in accordance with an embodiment;

FIGS. 3a-3e show schematic representations of production steps for producing the optical element in accordance with embodiments;

FIGS. 4a-4d show schematic diagrams of measurement results regarding the optical elements of FIGS. 1a to 2b for illustrating the mode of operation; and

FIGS. 4e and 4f show exemplary diagrams for illustrating thermal actuation.

### DETAILED DESCRIPTION OF THE INVENTION

Before embodiments of the present invention will be explained below in more detail with reference to the figures, it shall be noted that elements which are identical or have identical actions are provided with identical reference numerals, so that the descriptions thereof are mutually applicable or interchangeable.

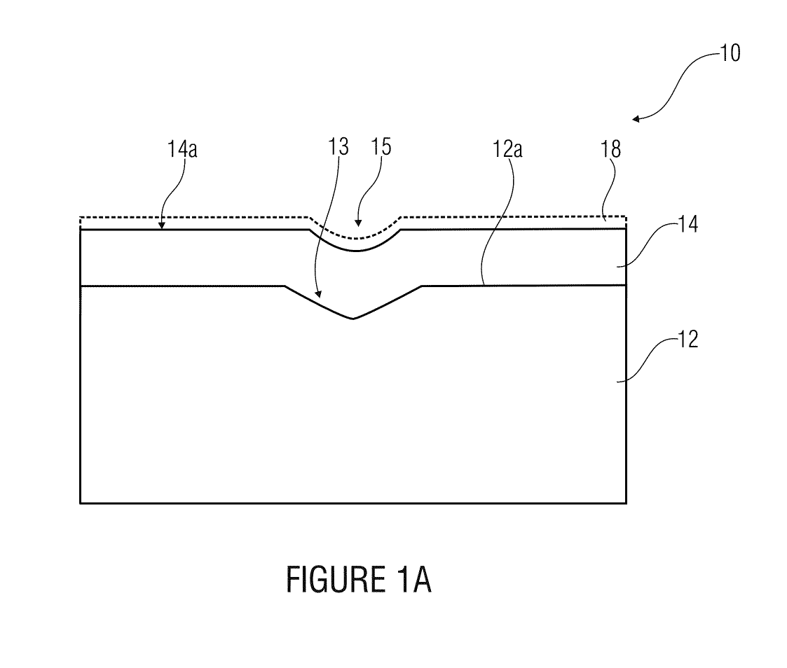

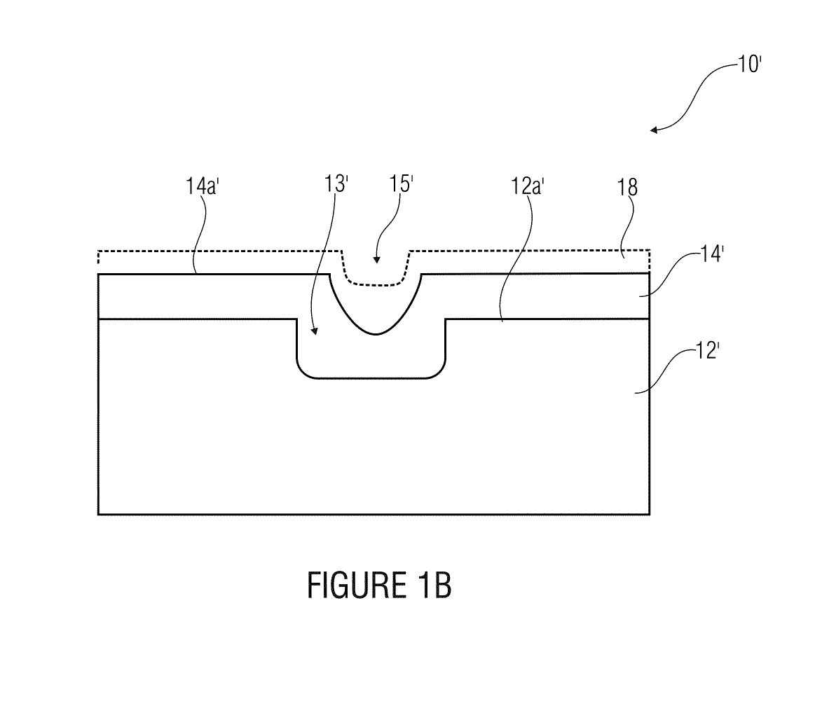

FIG. 1a shows an optical element 10 in the sectional representation with a structured carrier layer 12 and a layer 14 of cured material, which is arranged on the structured carrier layer 10, or on a first main surface 12a thereof. For example, the structured carrier layer 12 may be a photoresist applied to a substrate, or may be a structured substrate such as a glass or silicon substrate (silicon wafer), for example. The carrier layer 12 has, e.g., a thickness of 100 μm or generally a thickness within a range from 5 μm to 2 mm. The cured layer 14 typically includes a dielectric such as a polymer, PU (polyurethane) or a silicone (PDMS: polydimethylsiloxane), for example. The layer 14 forms an optical surface 14a facing away from the carrier layer 12. The optical surface 14a comprises a macro surface structure having an optical geometry 15, e.g. a concave geometry. This macro surface structure 15, which may have the shape of a concave depression, for example, is associated with a trench 13 introduced into the structured carrier layer 12. In other words, this means that the trench 13 or the macro surface structure 13 of the first main surface 12a of the carrier layer 12 is transferred through the layer 14 to the optical surface 14a of the layer 14, so that an optical geometry 15 is formed at this optical surface 14a.

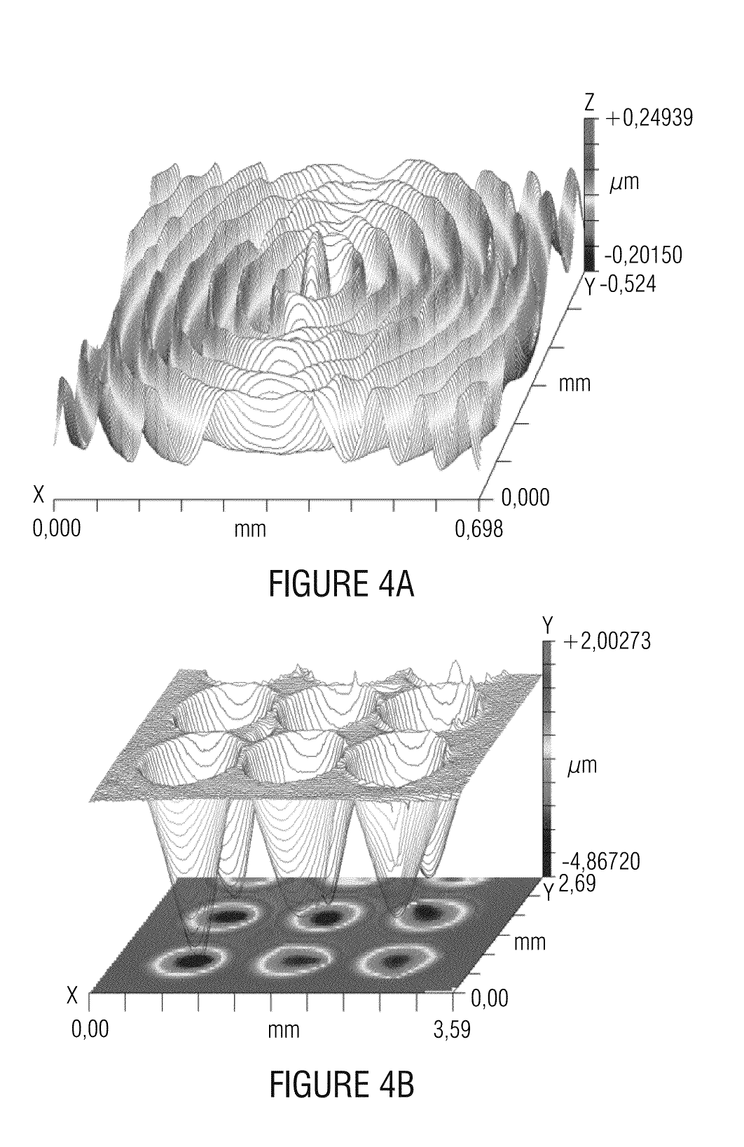

Thus, an optical element 10 may be directly produced, the optical geometry 15 being specified by the shape of the macro surface structure 13. In particular, said optical geometry 15 is determined in connection with the layer 14 and the curing behavior of the layer 14. Curing of the layer 14, wherein typically a shrinkage of same occurs, is such that the optically smooth surface 14a directly results, which has, for example, a roughness of 6.1 nm or generally a roughness Rₐ of less than 50 or less than 10 nm. This surface roughness Rₐ is also independent of the roughness of the carrier layer 12, which may exhibit, e.g., a roughness of 4850 nm or generally a roughness of more than 1000 nm. By implication, this means that the carrier layer 12 need not comprise the optical surface quality since any uneven spots are smoothened by the layer 14. The background of this will be explained within the context of the production method (cf. FIGS. 3a to 3e).

The optical element 10 represented may be operated either in reflection or transmission. For transmission, the layer 14 and the carrier layer 12 are then configured to be transparent. In case of operation in reflection, the optical surface 14a forms a mirror surface. To this end, an optical mirror layer 18, including, e.g., Al (aluminum), Au (gold) or Ag (silver), may optionally be applied to the optical surface 14a, the optical geometry 15 being directly transferred from the layer 14 onto the mirror layer 18. From that point of view, the layer 14 may also be referred to as an intermediate layer 14 in this embodiment having the optional mirror layer 18.

As was already mentioned above, the optical geometry 15 depends on the macro surface structure 13 of the carrier layer 12 and on the resulting curing-induced shrinkage of the layer 14. This becomes clear in particular with reference to FIG. 1b.

FIG. 1b shows a further optical element 10′ having a carrier substrate 12′ and a layer 14′ applied to said carrier layer 12′. It shall be noted at this point that the carrier layer 12′ and the applied layer 14′ fundamentally correspond (i.e. with regard to choice of material and production) to the layers 12 and 14 discussed in FIG. 1a. The difference is that the macro structure 13′ of the carrier layer 12′ is more pronounced, i.e. comprises a different shape and a different depth than in the previous embodiment. Specifically, a relatively deep trench 13′ (as compared to the trench 13 of FIG. 1a) is introduced in the main surface 12a′ of the carrier layer 12′. The result of this is that the optical geometry 15′ is also significantly more pronounced and comprises a modified shape. The change is shape is caused, in particular, by the curing-induced shrinkage, so that an approximately parabolic optical geometry 15′ results. The more pronounced manifestation is not caused merely by the fact that the trench 13′ is deeper. This becomes clear, in particular, when one considers that during production of the layer 14′, the surface 14a′ is planarized—prior to curing—by means of pressure or capillary forces, and/or results from a plane, and that the optical geometry 15′ results from the curing of the curable material of the layer 14. It shall be noted that the process of curing and/or the shrinkage due to cross-linking may be simulated back on the basis of the cured material, so that the surface 14a′ of the layer 14′ may virtually be transferred again into a plane while taking into account the temperature present during curing (i.e. the thermal expansion). Since the more pronounced manifestation of the optical geometry 15′ as compared to the embodiment of FIG. 1aresults from the fact that there is a larger amount of material of the curable optical material of the layer 14′ within the trench 13′, which leads to an increase in the absolute shrinkage upon curing of same.

By analogy with the above-mentioned embodiment, the optical element 10′ may be operated either in transmission or reflection and may consequently also comprise the optional mirror layer 18.

Such optical elements 10 and 10′ described in FIGS. 1a and 1b comprise low optical dispersions due to the materials used, which is important, in particular, for ultrashort pulse lasers, and they exhibit high destruction resistance as compared to LCoS SLMs (Liquid Crystal on Silicon Spatial Light Modulators).

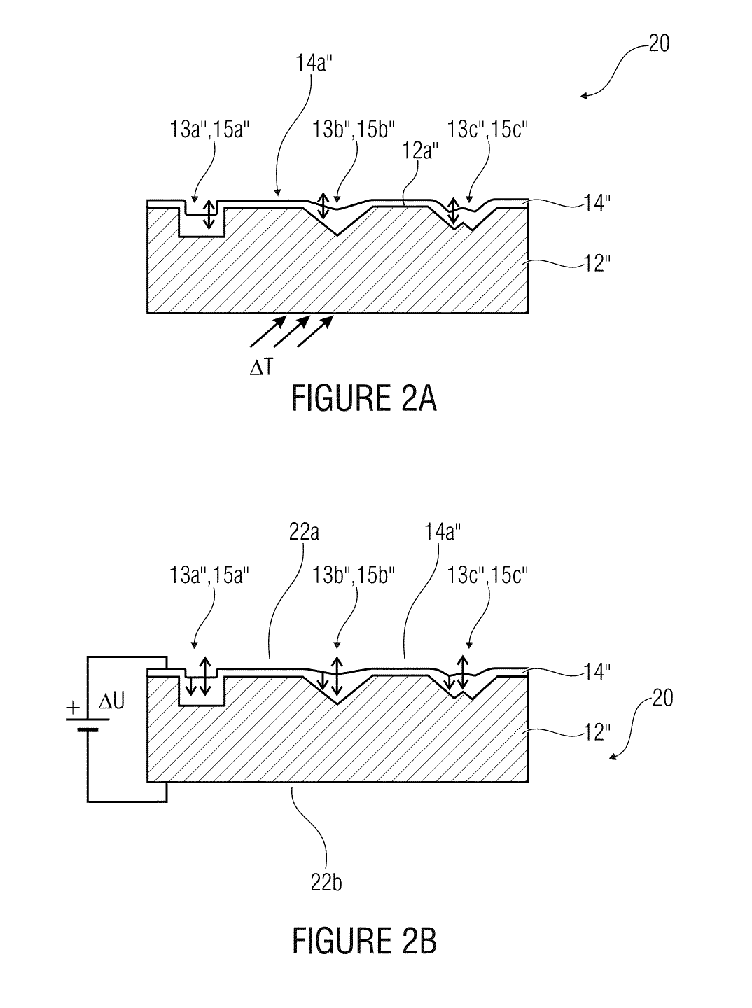

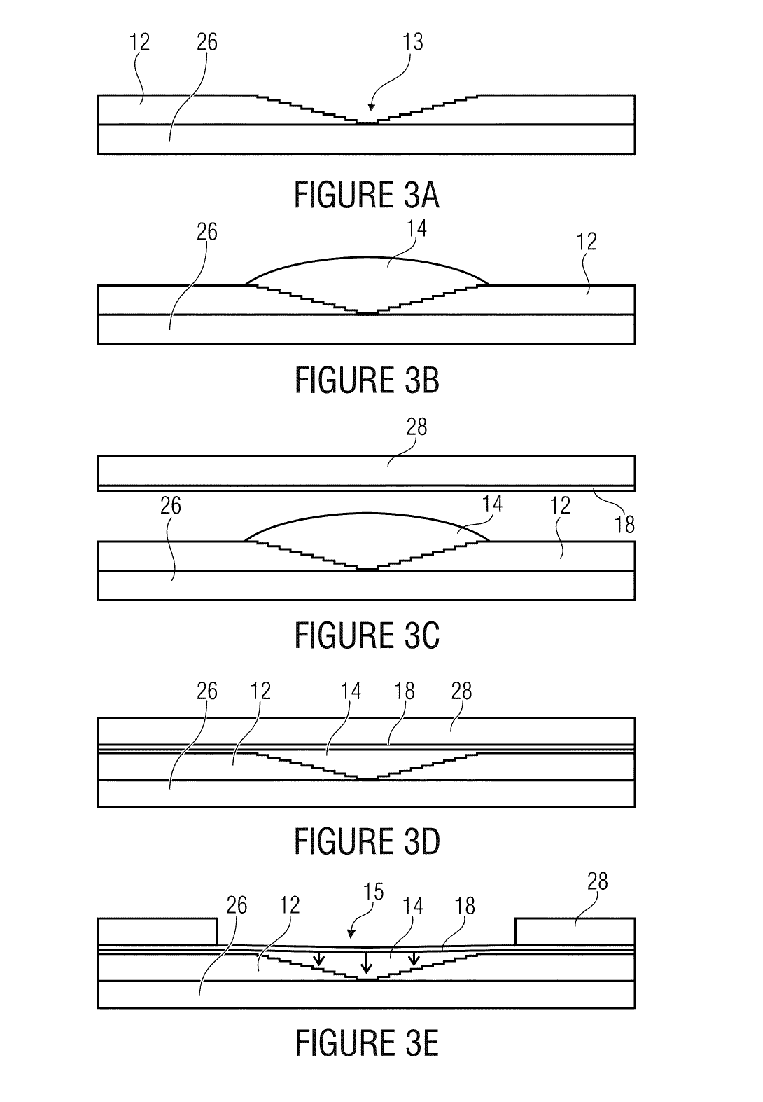

As will be explained in more detail below, the layer 14 and/or 14′ may be used for altering the macro surface structure 14a and 14a′ and/or the optical geometry 15 and 15a′ during operation. This process is also referred to as “actuating”. One distinguishes between thermal (cf. FIG. 2a) and electrostatic (cf. FIG. 2b) actuation.

FIG. 2a shows a thermal element 20 comprising a carrier layer 12″ having a plurality of trenches 13a″, 13b″ and 13C. Since the trenches 13a″, 13b″ and 13c″ have different shapes, the resulting optical geometries 15a″, 15b″ and 15c″ also have different shapes, such as a rectangular shape, a V shape or a W shape, for example. It shall further be noted that the optical element 20 may be operated both in transmission and in reflection, so that the optical element 20 may comprise the optional mirror layer (not depicted) on the surface 14a″.

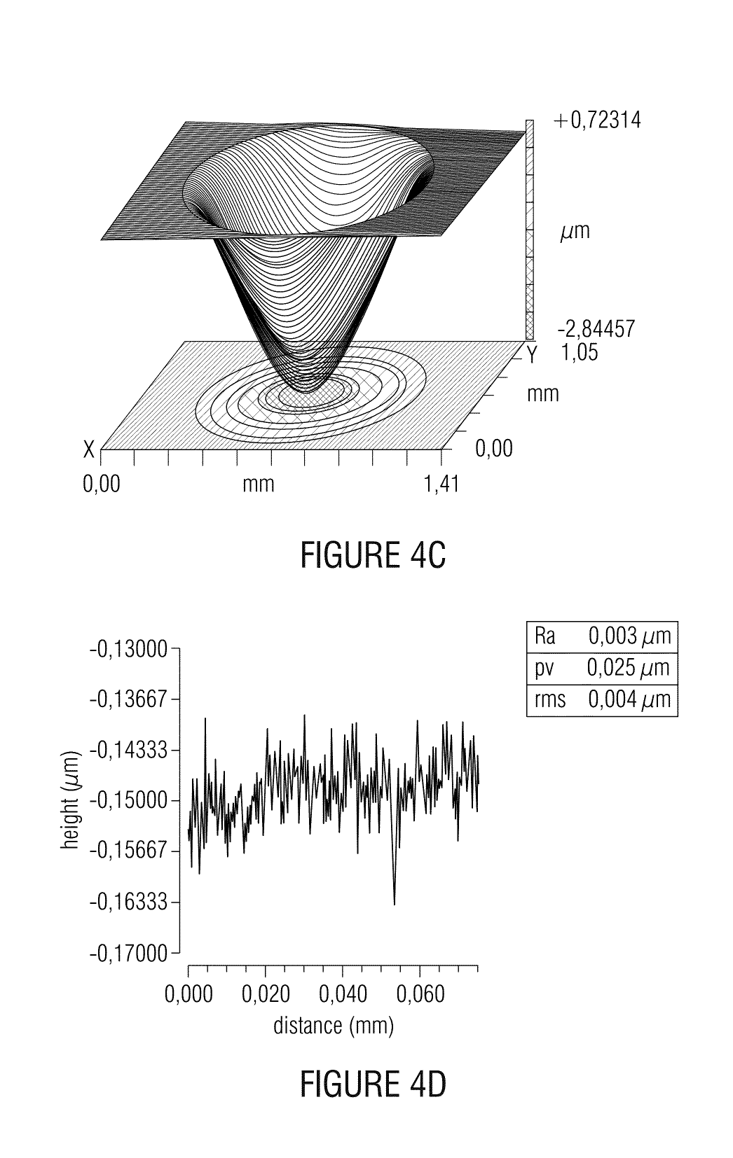

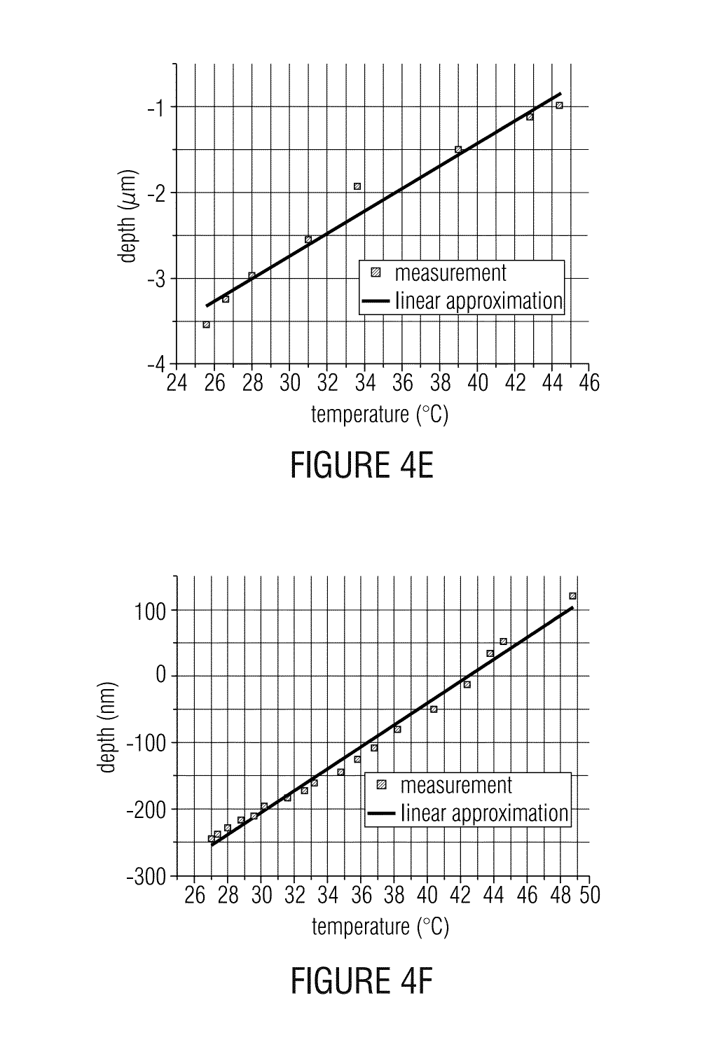

As was already indicated, the layer 14″ is configured to change its shape and, in particular, its macro surface structure 15a″, 15b″ and 15c″ as a result of a thermal influence. Since the intermediate layer 14″ has different thicknesses depending on the macro geometry of the carrier layer 12″ (cf. optical geometries 15a″ and 15c″), the optical geometries 15a″, 15b″ and 15c″ change to differing degrees, as in absolute terms, at an identical change in temperature AT, even if the extension per unit of volume is the same in terms of percentage. The “surface lifting” of the surface 14a depends, in addition to the trench depth (cf. trenches 13a″, 13b″ and 13c″), on the heat expansion coefficient of the employed layer material of the layer 14″ (cf. FIGS. 4e and 4f). With this effect, the amplitude of the surface function 14a″ and, thus, the phase of the optical element 20 may be adapted with regard to the electromagnetic waves to be reflected or transmitted.

FIG. 2b shows the optical element 20 from FIG. 2a, two electrodes 22a and 22b being applied here. The electrode 22a is associated with the optical surface 22a″, whereas the electrode 22b is associated with the carrier layer 12″. The electrodes 22a and 22b are typically vapor-deposited and may include, e.g., gold, aluminum or transparent and electrically conductive indium tin oxide, for example. Thus, the electrode 22a may be formed, e.g., on the optical surface 14a″, through the mirror layer (not shown). The electrode 22b is advantageously arranged on a substrate (not shown) of the carrier layer 12″, i.e. on sides of a second main surface located opposite the first main surface of the carrier layer 12″.

By applying a voltage AU between the two electrodes 22a and 22b, an electrostatic force may be exerted on the layer 14″, so that the latter is elastically deformed accordingly. Said electrostatic deformation has the same effect as thermal deformation, which is described in FIG. 2a. The difference between the two types of deformation is that thermal actuation is typically slower-acting than electrostatic actuation, so that electrostatic actuation may be operated at higher frequencies as compared to thermal actuation. By implementation, this means that the basic expansion is caused by thermal deformation, whereas short-term changes occur due to electrostatic actuation. This is why, in accordance with further embodiments, a combination of the mechanisms of action shown in FIGS. 2a and 2b is possible; however, it shall be pointed out that advantageously, only one type of actuation (electrostatic or thermal) may be selected so as to keep the optical element and the actuation simple (for example if there is a need to perform the actuation only by means of one control signal).

The production method of the above-described optical elements will be described with reference to FIGS. 3a to 3e. FIG. 3a shows a first process step wherein a carrier layer 12 applied to a substrate 26, which includes silicon, glass or ceramics, for example, is structured, so that the macro structure 13 arises in the shape of a V.

Said patterning of the carrier layer 12, which may comprise a thickness of 100 μm, for example, is effected, e.g., by means of a laser writing a stepped profile into the resist. Other patterning methods such as gray-scale lithography, layer-by-layer lithography, drilling, milling, 2-photon 3D lithography (e.g. with Nanoscribe) would also be feasible. With said methods, almost any patterning of the photoresist 12 and, thus, any optical geometries 13 can be produced, since, as will be set forth below, any roughness of the surface of the carrier layer 12 which results during patterning (cf. stepped profile) does not have an effect on the optical surface of the layer 14 yet to be applied.

FIG. 3b shows a next process step wherein the layer 14 including, e.g., a soft dielectric such as PDMS, PU or epoxy resin, for example, is applied to the structured carrier layer 12. This step is advantageously performed such that the curable layer material fills up, in a liquid form, at least the macro structure 13. Following application, the layer 14 applied here typically exhibits a raised structure as compared to the surface of the carrier layer 12. To avoid inclusions of air, this production step may be performed under a vacuum atmosphere.

FIG. 3c shows the creation of the optical surface 14a which, as was already set forth above, may be configured such that the optical element is operable either in transmission or in reflection. In the following, this production step will be explained in a manner exemplary of an optical element operable in reflection.

Here, a mirror substrate 28 comprising the mirror layer 18 is pressed onto the structured carrier layer 12 provided with the liquid, curable layer material for the layer 14. This step is performed at a defined pressure following alignment of the mirror substrate 28 with the carrier layer 12, so that the surface 14a is smoothened in the process or that the surface 14a is formed by the optically smooth mirror layer 18 (roughness<20 nm) itself.

The mirror substrate 28 may be a silicon substrate, for example, which has Si₃N₄ deposited on both sides thereof. A reflecting layer 18 including, e.g., Al, Au or Ag, is vapor-deposited onto said mirror substrate 28. The type and thickness of the coating may be adapted to the respective application. For example, the layer 18 may be transparent if the optical element is to be operated in transmission. The nitride layer (Si₃N₄) on the rear side of the mirror substrate 28 may be opened either using laser radiation or by means of photolithography with subsequent wet-chemical etching after force fitting.

FIG. 3d shows the production step wherein the curable layer material of the layer 14 or of the intermediate layer 14 is cured or cross-linked under the influence of temperature. This results in a volume shrinkage, for example by at least 0.05% or by 1% or even by 5%, so that the previously raised layer material is planar. This process is performed within a temperature range from 20° C. to 220° C., for example. It shall be noted that, due to the force fitting or cross-linking, the layer material may form a thin layer on the surface of the carrier layer 12, i.e. between the carrier layer 12 and the mirror layer 18. Depending on the temperature and the pressure employed, cross linking of the soft layer material entails a change in the density thereof and the emergence of the optical properties, and in particular the definition of the optical geometry.

Since the mirror substrate 28 absorbs the internal stresses of the cured or cross-linked intermediate layer 14, the optical geometry does not yet result after this process step. To create same, the mirror substrate 28 is at least partly removed in the next step.

FIG. 3e shows the step of removing the mirror substrate 28. The optical element (the chip) is unilaterally etched, for example by means of KOH etching (potassium hydroxide etching) or by means of dry etching using ICP (inductively coupled plasma) or, alternatively, using XeF₂ (xenon difluoride), so that the mirror substrate 28 is partly removed. The silicon nitride layer (Si₃N₄, not shown) between the mirror substrate 28 and the mirror layer 18 acts as an etch stop, so that the mirror layer 18 is not attacked during etching. Advantageously, etching is performed in isolated places in the optically active areas.

As is shown in FIG. 3e, the internal stresses of the intermediate layer 14, and, thus, of the mirror layer 18 connected to it, provide the resulting initial state, or the optical geometry 15, once the mirror substrate 28 has been removed. Depending on the actuation envisaged, further process steps may now follow.

For electrostatic actuation, the previously applied electrode (not shown) on the base substrate 26 and the electrode (mirror layer 18) on the mirror substrate 28 are electrically contacted. This may be followed by a step of casting the electrodes with epoxy resin so as to prevent electrical breakdown caused by air. As was already explained above, it is possible to either control all of the elements of the array at the same time or to perform contacting such that individual triggering of the individual optical elements is possible. Further electrodes may possibly be provided for this purpose.

In addition, in accordance with further embodiments, the optical element may be connected, for thermal actuation, to thermal elements, such as for heating or cooling, for example, following the production step of FIG. 3e. Typical forms of implementation in this context are resistance heater, Peltier elements, water cooler or water heater, which are arranged on the second main surface of the carrier layer 12 or at the associated substrate. In accordance with further embodiments, it is also possible to directly integrate the thermal actuator system into the optical element, so that for example a resistance heater or an on-chip Peltier element may be introduced into the substrate 26 already prior to the production step shown in FIG. 3a.

Since this production method is based on individual production technologies from semiconductor production, simple miniaturization of the optical elements thus produced is possible.

FIG. 4a shows a white-light interferometric measurement of a reflective grating at room temperature. Here, the height z of the structure is plotted versus the optical surface (cf. x/y axes). PDMS Sylgard 184 is used as the dielectric material of the grating. It shall be noted that the measurement relates to the deflection from the maximum to the minimum of the sinusoidal grating. The height z of the structure of the mold amounts to 10 μm, the deflection of the grating amounting to 450 nm, and the grating constant being d=50 μm.

FIG. 4b shows a white-light interferometric measurement of an array comprising a multitude of conical axicon mirrors with parabolic tips. The layer material of the intermediate layer which is used here includes PDMS SE1740. In the measurement depicted in FIG. 4b, the height z of the structure is again plotted versus the optical surface (xy plane). The height z of the structure of the mold amounts to 100 μm. The deflection of the axicon is 5.5 μm given an individual-element diameter of 900 μm.

FIG. 4c shows a white-light interferometric measurement at room temperature of an individual axicon mirror wherein the cured layer material PU Vytaflex 10 is used. Again, the height z of the structure is plotted versus the optical surface (xy). The height z of the structure of the mold amounts to 100 μm. The deflection of the axicon is 3.5 μm given an element diameter of 900 μm.

As may be seen from FIGS. 4a to 4c, the layer material of the intermediate layer (cf. layer 14) which is used has a considerable influence on the resulting optical geometry.

FIG. 4d shows a white-light interferometric measurement of the surface roughness Rₐ of the optical mirror surface at a location exposed by etching. The surface roughness Rₐ amounts to a maximum of 3 nm.

With reference to FIGS. 4e and 4f, thermal activation of optical elements will be explained by means of exemplary diagrams.

FIG. 4e shows the deflection of an axicon mirror wherein PU Vytaflex 10 (cf. axicon mirror of FIG. 4c) is used as the dielectric material, depending on the temperature of the component. It shall be noted that here the deflection was measured at the central low point of the axicon. The height z of the structure of the mold is 100 μm, a change in the structural height arising which, as is shown in diagram 4e, is approximately linear within the range from 27° C. to 43° C. The slope defines the “height of lift” and, thus, the potential thermal actuation, e.g. 1 μm per 8° C.

FIG. 4f shows a diagram of the deflection of a reflective grating wherein PDMS Sylgard 184 (cf. axicon mirror of FIG. 4b) was used, plotted versus the temperature of the component. It shall be noted that for measuring the deflection comprised measuring the deflection from the minimum to the maximum of the grating in each case. The structure of the initial state amounts to 10 μm; again, an approximately linear curve (within the range from 27° C. to 48° C.) arising for the change in the height z of the structure (e.g. 100 nm per 8° C.).

With reference to FIGS. 2a and 2b, it shall be noted that the optical elements 20 depicted may also be arranged on a substrate, different types being possible here. In particular, one has to distinguish that in the event of electric actuation, the substrates used are advantageously not conductive, whereas in the event of thermal actuation, it is also possible to employ electrically conductive silicon or metal as the substrate material.

It shall be noted with reference to FIG. 3a that, following the patterning, dicing of the optical elements may be effected, e.g. by means of wafer sawing, for example if a silicon wafer is used as the substrate 26.

With reference to the production step of FIG. 3d, it would alternatively also be possible to remove the layer 18 so that the optically smooth surface is formed by the planarized layer 14 itself.

In accordance with further embodiments, it is also possible for a multitude of different elements 20 to be arranged on a common substrate, so that an array is formed which comprises individual controllable or lockable optical elements. Thus, the array or the individual optical elements of the array may be adjusted, via exploiting the thermal effect, such that the desired fundamental deflection of the optical surface occurs in a constant manner. The individual elements of the array are then triggered separately via electric actuation.

As was already explained above, almost any (spherical and aspherical) optical geometries such as spherical mirrors, parabolic mirrors or axicon mirrors, for example, but also diffraction gratings and diffractive holograms may be implemented. Moreover, further embodiments relate to adaptive (reflective) diffraction gratings (blazed gratings) and to adaptive holograms wherein the optical element may be adapted to the wavelength of the respective field of application by adjusting the phase deviation. Thus, a diffraction grating may be employed for a multitude of different applications in that it is adapted to the wavelength used in each case, for example the wavelength of the laser, by means of the actuations described above.

In accordance with further embodiments, the optical elements presented above may be integrated into electric (semiconductor) components on the basis of the possibility of miniaturization, so that optical elements are mounted directly on a chip.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An optical element comprising:
a structured carrier layer comprising a macrostructure at a main surface; and
a layer of cured material comprising an optically smooth surface facing away from the main surface, a macro surface structure of the surface being dependent on the macrostructure of the carrier layer and on a layer thickness profile of the layer.

2. The optical element as claimed in claim 1, wherein the macro surface structure has resulted from a plane due to curing-induced shrinkage and thermal expansion while the macrostructure has been influenced.

3. The optical element as claimed in claim 1, wherein the macro surface structure and/or the layer thickness profile form an optical geometry.

4. The optical element as claimed in claim 1, further comprising a mirror layer arranged on the surface of the layer, so that the mirror layer has the macro surface structure embossed therein and that the mirror layer comprises an optically smooth surface.

5. The optical element as claimed in claim 1, wherein the layer is configured to undergo a variation of the layer thickness profile as a result of a change in temperature and/or as a result of an electrostatic change.

6. The optical element as claimed in claim 5, further comprising a first electrode associated with the carrier layer and a second electrode associated with the surface of the layer, the first and second electrodes being configured to electrostatically change the layer thickness profile of the layer if an electric voltage is applied between them.

7. The optical element as claimed in claim 6, wherein the second electrode is formed by a mirror layer.

8. The optical element is claimed in claim 5, further comprising a temperature-changing element configured to increase and/or lower the temperature of the layer.

9. The optical element as claimed in claim 6, wherein the layer thickness profile comprises a first area comprising a small layer thickness and a second area comprising a large layer thickness, and
wherein an absolute variation of the macro surface structure is smaller in an area associated with the first area than an absolute variation of the macro surface structure in an area associated with the second area.

10. The optical element as claimed in claim 5, wherein the layer is configured to perform the variation of the layer thickness profile, which is the result of the change in temperature, at a lower frequency than the variation of the layer thickness profile which is the result of the electrostatic change.

11. The optical element as claimed in claim 1, wherein the layer comprises a dielectric or a polymer.

12. The optical element as claimed in claim 1, wherein a roughness of the optical surface is smaller by at least a factor of 50 than a roughness of the main surface.

13. The optical element as claimed in claim 1, wherein the optical geometry is an aspherical, spherical or parabolic one or forms an axicon, diffraction gratings or diffractive holograms.

14. The optical element as claimed in claim 5, wherein the optical geometry forms a diffraction grating wherein the optical element is adaptable, by varying the layer thickness profile, to a wavelength of an electromagnetic wave to be diffracted.

15. An optical array comprising a multitude of adjacently arranged optical elements as claimed in claim 1.

16. A method of producing an optical element, comprising:
providing a carrier layer;
structuring the carrier layer, so that a macrostructure is formed at a main surface;
applying a layer of curable material, so that an optically smooth surface facing away from the main surface arises and a macro surface structure of the surface is dependent on the macrostructure of the carrier layer and on a layer thickness profile of the layer.

17. A method of producing as claimed in claim 16, further comprising the step of applying a mirror layer to the layer, so that the mirror layer has the macro surface structure embossed therein and that the mirror layer comprises an optically smooth surface.

18. Method The method of producing as claimed in claim 16, wherein said application of the mirror layer is performed such that planarization of the layer occurs.

19. The method of producing as claimed in claim 18, wherein said application of the mirror layer is performed with the aid of a mirror substrate, and
said method further comprising exposing the mirror substrate at least in such areas which are associated with intermediate-layer areas comprising internal stresses.

20. The method of manufacturing as claimed in claim 16, further comprising, following said application of the layer, curing the layer, so that cross-linking of the layer occurs.

21. The method of producing as claimed in claim 20, wherein said curing is performed such that shrinkage of the layer occurs.

22. The method of producing as claimed in claim 20, wherein said curing is performed such that the cured material of the layer is configured to undergo a variation of the layer thickness profile as a result of a change in temperature and/or as a result of an electrostatic change.
